(19) United States
(12) Patent Application Publication
(10) Pub. No.: US 2012/0077003 A1
(43) Pub. Date: Mar. 29, 2012

(54) METHOD OF NONLINEAR CRYSTAL PACKAGING AND ITS APPLICATION IN DIODE PUMPED SOLID STATE LASERS

(76) Inventor: Ye Hu, Ontario (CA)

(21) Appl. No.: 13/377,394

(22) PCT Filed: Dec. 31, 2010
(86) PCT No.: PCT/CA2010/002070

§ 371 Date: Dec. 9, 2011

Related U.S. Application Data
(60) Provisional application No. 61/291,367, filed on Dec. 31, 2009.

(51) Int. Cl. B32B 7/02; B32B 37/06; B32B 15/04; B32B 9/04; B32B 27/38

(52) U.S. Cl. 428/213; 428/702; 428/413; 428/457; 156/272.8

(57) ABSTRACT

The present invention is related to methods of packaging optical nonlinear crystal with a periodically domain inversion structure (e.g. periodically poled MgO doped lithium niobate) which is bonded with a laser crystal (e.g. Nd doped YVO₄) and to achieve efficient second harmonic generation in an intra-cavity configuration.

### BACKGROUND OF THE INVENTION

1. Field of the Invention

The present invention relates to methods of packaging optical nonlinear crystal based on the quasiphase matching (QPM) technique, which can be used to generate light in a wavelength range from UV to mid-IR.

2. Description of the Related Art

In the development of the second harmonic (SHG) lasers based the QPM optical nonlinear crystals, optimized packaging of the QPM crystals is necessary. Usually the diode pumped solid state (DPSS) SHG lasers is formed by a pump laser diode (e.g. a semiconductor laser diode lasing at 808 nm), a laser crystal (e.g. Nd doped YVO₄), a QPM crystal (e.g. MgO doped periodically poled lithium niobate or MgO:PPLN), and an optical output coupling mirror. The facets of the laser crystal and the QPM crystal are properly coated with either high reflection (HR) or anti-reflection (AR) films so that the fundamental light is confined in the laser cavity while the SHG light is coupled out the laser cavity efficiently. The QPM crystal acts as a second harmonic generator in which a periodical domain inversion grating is formed along the grating direction so as to satisfy the QPM condition. By pumping a laser crystal (i.e. Nd doped YVO₄) with a pump laser diode with a lasing wavelength of 808 nm, fundamental light of a wavelength λ (i.e. 1064 nm) is generated within a laser cavity. If the period of the QPM crystal is selected properly so that the QPM wavelength of the nonlinear crystal matches with the fundamental wavelength, a second harmonic light at a wavelength of λ/2 (i.e. 532 nm) can be generated efficiently. The period of the domain inversion grating Λ is decided by the QPM condition (i.e. 2 (n_{2ω}-n_{ω})=λ/Λ, where n_{2ω} and n_{ω} are refractive indices at SH and fundamental light, respectively).

To achieve efficient wavelength conversions, reduce size and packaging cost of the lasers, a bonded structure is usually employed, in which the laser crystal 2 (e.g. Nd doped YVO₄) and nonlinear crystal 3 (e.g. MgO:PPLN) is bonded together, as shown in FIG. 1. To confine the fundamental light within the laser cavity, reduce coupling loss of pump power and couple SH light efficiently from the cavity, the laser crystal 2 is coated with a film 1, which has HR at wavelengths of fundamental and SH light (e.g. 1064 nm and 532 nm) but AR at the wavelength of the pumping light (e.g. 808 nm), while nonlinear crystal 3 is coated with a film 4, which has 1-JR at fundamental light (e.g. 1064 nm) and AR at SH light (e.g. 532 nm).

In fact, the above described technique using the bonded nonlinear crystal is well known and has been disclosed in a number of literatures, such as Moravian, et al., U.S. Pat. No. 4,953,166, Microchip laser, Feb. 9, 1989; J. I. Zayhowski et al., “Diode-pumped passively Q-switchcd picosecond microchip lasers”, Optics Letters, vol. 19, p. 1427 (1994); R. Fluck, et al., “Passively Q-switched 1.34-micron Nd:YVO₄ microchip laser with semiconductor saturable-absorber mirrors,” Optics Letters, vol. 22, p. 991 (1997); U.S. Pat. No. 5,295,146, Mar. 15, 1994. Gavrilovic, et al., Solid state gain mediums for optically pumped monolithic laser; U.S. Pat. No. 5,574,740, Aug. 23, 1994. Hargis, et al., Deep blue microlaser; U.S. Pat. No. 5,802,086, Sep. 1, 1998. Hargis, et al., High-efficiency cavity doubling laser; U.S. Pat. No. 7,149,231, Dec. 12, 2006. Afzal, et al., Monolithic, side-pumped, passively Q-switched solid-state laser; U.S. Pat. No. 7,260,133, Aug. 21, 2007. Lei, et al., Diode-pumped laser; U.S. Pat. No. 7,535,937, May 19, 2009. Luo, et al., Monolithic microchip laser with intra-cavity beam combining and sum frequency or difference frequency mixing; U.S. Pat. No. 7,535,938, May 19, 2009; Luo, et al., Low-noise monolithic microchip lasers capable of producing wavelengths ranging from IR to UV based on efficient and cost-effective frequency conversion; U.S. Pat. No. 7,570,676, Aug. 4, 2009. Essaian, et al., Compact efficient and robust ultraviolet solid-state laser sources based on nonlinear frequency conversion in periodically poled materials; USPC Class: 372 10, IPC8 Class: AH01S311FI, Essaian, et al.; R. F. Wu, et al., “High-power diffusion-bonded walk-off-compensated KTP OPO”, Proc. SPIE, Vol. 4595, 115 (2001); Y. J. Ma, et al., “Single-longitudinal mode Nd:YVO₄ microchip laser with orthogonal-polarization bidirectional traveling-waves mode”, 10 Nov. 2008, Vol. 16, No. 23, OPTICS EXPRESS 18702; C. S. Jung, et al., “A Compact Diode-Pumped Microchip Green Light Source with a Built-in Thermoelectric Element”, Applied Physics Express 1 (2008) 062005.

The bonding can be achieved by using either adhesive epoxy or the direct bonding technique. Since epoxy can be damaged at high optical power, the direct bonding or optical bonding technique has to be used for high power SHG lasers although the process of adhesive epoxy bonding is much easier than that of the direct bonding.

The bonded nonlinear crystal can be traditional nonlinear crystal such as KTP or periodically poled crystal such as PPLN. The laser employing the bonded nonlinear crystal can either based on second harmonic generation (SHG) or sum frequency generation (SFG) or difference frequency generation (DFG). Since nonlinear coefficient of KTP is much less than that of PPLN, it is preferred to use PPLN as a nonlinear crystal in the SHG lasers from laser efficiency point of view.

However, bonded structure using nonlinear crystal has several issues, which are especially serious for PPLN crystal. First, laser performance is degraded by thermal effects due to the poor thermal conductivity of the nonlinear crystal and laser crystal. This is especially critical for the high power SHG lasers (e.g. >100 mW). Second, different from KTP, nonlinear crystals with periodical domain inversion structures (e.g. MgO:PPLN) usually have small thickness (typically 0.5 mm). As a result, it is hard to bond directly with the laser crystal due to the limited cross section of the bond surfaces.

### SUMMARY OF THE INVENTION

The objective of the present invention is to provide methods to overcome the problems involved in DPSS lasers including a nonlinear crystal with a bonded structure. In these methods, substrates with high thermal conductivity are introduced to remove the heat generated in the laser and nonlinear crystals, and to increase the cross section of the bonding surfaces of both laser crystal and nonlinear crystal.

According to one aspect of the present invention, as shown in FIG. 2, a laser crystal 2 and a nonlinear crystal 3 are first bonded with substrates 5, 6, respectively, and then bonded together. The substrates 5, 6 have high thermal conductivity and the same thickness. The bonding 7, 8 between the laser crystal 2 and substrate 1, and between the nonlinear crystal 3 and substrate 2 can be either direct bonding or epoxy bonding, while the bonding between the laser crystal 2 and nonlinear crystal 3 is direct bonding since epoxy should not exist in optical pass, which is especially important for high power DPSS lasers. The thickness of the substrates is properly selected so that the cross section is large enough for easy bonding. The facets of the laser crystal and the nonlinear crystal are properly coated with either high reflection (HR) or anti-reflection (AR) films 1, 4 so that the fundamental light is confined in the laser cavity while the SHG light is coupled out the laser cavity efficiently. In the case of green DPSS lasers, film 1 has HR at wavelengths of fundamental and SH light (e.g. 1064 nm and 532 nm) but AR at the wavelength of the pumping light (e.g. 808 nm), while film 4 has HR at fundamental light (e.g. 1064 nm) and AR at SH light (e.g. 532 nm). The second harmonic generation occurs only in the nonlinear crystal 3 in which the phase matching condition is satisfied. By pumping a laser crystal (i.e. Nd doped YVO₄) with a pump laser diode at a lasing wavelength of 808 nm, fundamental light of a wavelength λ (i.e. 1064 nm) is generated within a laser cavity. If the nonlinear crystal is selected properly so that the phase matching condition is satisfied, a second harmonic light at a wavelength of λ/2 (i.e. 532 nm) can be generated efficiently.

### BRIEF DESCRIPTION OF THE DRAWINGS

The present invention will be understood more fully from the detailed description given herein below, taken in conjunction with the accompanying drawings.

In the drawings:

FIG. 1 is a schematic drawing of a prior art of a bonded nonlinear crystal and laser crystal for a DPSS SHG laser.

FIG. 2 is a schematic diagram for explaining the concept of one method to achieve a bonded structure according to the present invention.

FIG. 3 is a schematic diagram for explaining the concept of the method described in the first preferred embodiment to achieve a bonded structure according to the present invention.

FIG. 4 is a schematic diagram for explaining the concept of the method described in the second preferred embodiment to achieve a bonded structure according to the present invention.

FIG. 5 is a schematic diagram for explaining the concept of the method described in the third preferred embodiment to achieve a bonded structure according to the present invention.

FIG. 6 is a schematic diagram for explaining the concept of the method described in the forth preferred embodiment to achieve a bonded structure according to the present invention.

FIG. 7 is a schematic diagram for explaining the concept of the method described in the fifth preferred embodiment to achieve a DPSS SHG laser according to the present invention.

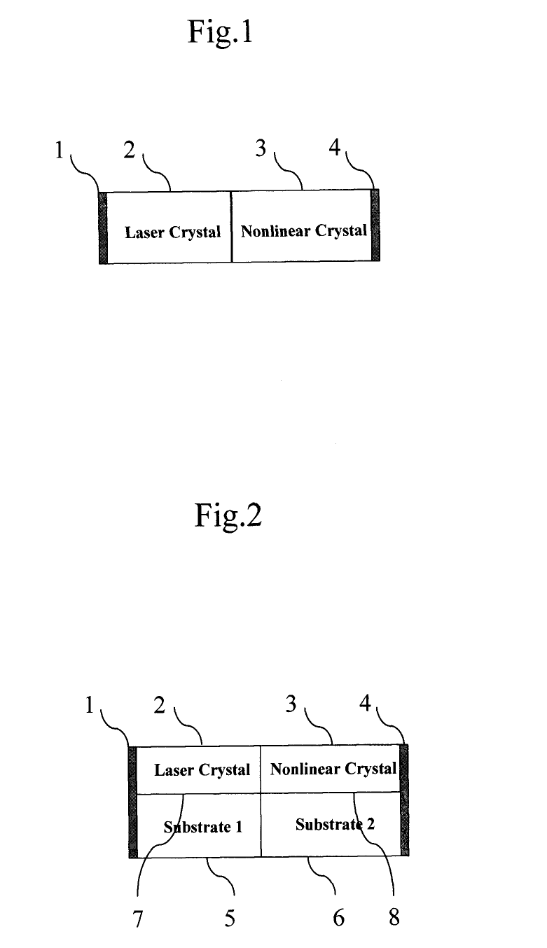

### DETAILED DESCRIPTION OF PREFERRED EMBODIMENTS

The present invention solves the foregoing problems by means described below.

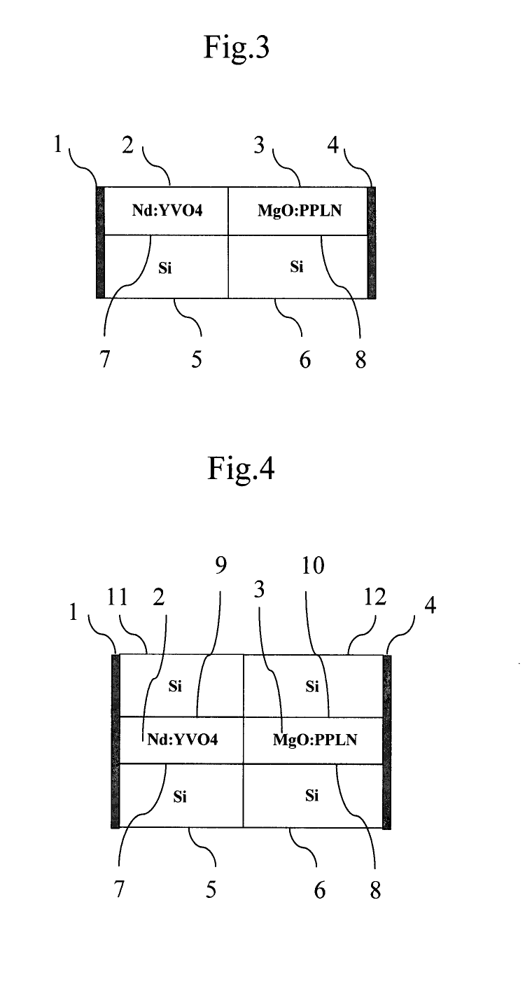

In the first preferred embodiment, a bonding structure for DPSS lasers is shown in FIG. 3. A laser crystal (e.g. Nd:YVO₄) 2 and a nonlinear crystal (e.g. MgO:PPLN) 3 are first bonded with substrates (Si substrates) 5, 6, respectively. The typical thickness of the laser crystal and nonlinear crystal can be used here (e.g. 0.5 mm), while the thickness of the Si substrates is properly selected (e.g. 0.5 mm˜2.5 mm) so that the cross section is large enough for easy facet bonding to be carried out later. The bonding between laser crystal 2 and Si substrate 5, and between nonlinear crystal 3 and Si substrate 6 can be done using large wafer size to reduce the overall manufacturing cost. The Si substrates 5, 6 have high thermal conductivity and the same thickness. The bonding 7, 8 between the laser crystal 2 and Si substrate 5, and between nonlinear crystal 3 and Si substrate 6 can be epoxy bonding although higher cost direct bonding is also acceptable. After dicing and polishing facet, the laser crystal 2 and nonlinear crystal 3 is then directly bonded together without epoxy. In the meantime, Si substrates under the laser crystal and nonlinear crystal are also directly bonded without epoxy. Epoxy should not exist in optical pass, which is especially important for high power DPSS lasers. The out facets of the laser crystal and the nonlinear crystal are in parallel and properly coated with either high reflection (HR) or anti-reflection (AR) films 1, 4 so that the fundamental light is confined in the laser cavity while the SHG light is coupled out the laser cavity efficiently. In the case of green DPSS lasers, film 1 has HR at wavelengths of fundamental and SH light (e.g. 1064 nm and 532 nm) but AR at the wavelength of the pumping light (e.g. 808 nm), while film 4 has HR at fundamental light (e.g. 1064 nm) and AR at SH light (e.g. 532 nm). The bonded crystal is flipped over so that the laser crystal and nonlinear crystal are contacted directly with a heat sink or metal mount to remove the heat generated in the crystals. The second harmonic generation occurs only in the nonlinear crystal 3 in which the QPM condition is satisfied. By pumping a laser crystal (i.e. Nd doped YVO₄) with a pump laser diode with a lasing wavelength of 808 nm, fundamental light of a wavelength λ (i.e. 1064 nm) is generated within a laser cavity. If the nonlinear crystal is selected properly so that the phase matching condition is satisfied, a second harmonic light at a wavelength of λ/2 (i.e. 532 nm) can be generated efficiently.

Based on the description above, it is easy to understand that the heat generated in the laser crystal and nonlinear crystal can be removed easily due to the high thermal conductivity of Si substrate and metal mount. In addition, since the overall cross section of the direct bonding facets are increased significantly (from 0.5 mm to more than 1 mm), the difficulty involved in direct bonding of the facet in the previous bonding process can be solved. Furthermore, considering the fact that the light beam diameter in a DPSS laser is usually only 50 μm, the thickness of the laser crystal and nonlinear crystal can be reduced down to 100˜200 μm to further enhance efficiency of removing the heat generated in the crystals.

In the second preferred embodiment of the present invention, a bonding structure for DPSS lasers is shown in FIG. 4. A laser crystal (e.g. Nd:YVO₄) 2 and a nonlinear crystal (e.g. MgO:PPLN) 3 are first bonded with substrates (Si substrates) 5, 6, respectively. The typical thickness of the laser crystal and nonlinear crystal can be used here (e.g. 0.5 mm). The thickness of the laser crystal and nonlinear crystal can be reduced down to 100˜200 μm. Then the laser crystal and nonlinear crystal are bonded with other Si substrates 11, 12, respectively. The thickness of the Si substrates is properly selected (e.g. 0.5 mm˜2.5 mm) so that the cross section is large enough for easy facet bonding to be carried out later. The bonding between laser crystal 2 and Si substrate 5, 11 and between nonlinear crystal 3 and Si substrate 6, 12 can be done using large wafer size to reduce the overall manufacturing cost. The Si substrates 5, 6, 11, 12 have high thermal conductivity and substrates 5 and 6 have the same thickness, and substrates 11, 12 also have the same thickness. The bonding 7, 8, 9, 10 between the laser crystal 2 and Si substrates 5, 11, and between nonlinear crystal 3 and Si substrate 6, 12 can be epoxy bonding although higher cost direct bonding is also acceptable. After dicing and polishing facet, the laser crystal 2 and nonlinear crystal 3 is then directly bonded together without epoxy. In the meantime, Si substrates that sandwich the laser crystal and nonlinear crystal are also directly bonded without epoxy. Epoxy should not exist in optical pass, which is especially important for high power DPSS lasers. The out facets of the laser crystal and the nonlinear crystal are in parallel and properly coated with either high reflection (HR) or anti-reflection (AR) films 1, 4 so that the fundamental light is confined in the laser cavity while the SHG light is coupled out the laser cavity efficiently. In the case of green DPSS lasers, film 1 has HR at wavelengths of fundamental and SH light (e.g. 1064 nm and 532 nm) but AR at the wavelength of the pumping light (e.g. 808 nm), while film 4 has HR at fundamental light (e.g. 1064 nm) and AR at SH light (e.g. 532 nm). The second harmonic generation occurs only in the nonlinear crystal 3 in which the QPM condition is satisfied. By pumping a laser crystal (i.e. Nd doped YVO₄) with a pump laser diode with a lasing wavelength of 808 nm, fundamental light of a wavelength λ (i.e. 1064 nm) is generated within a laser cavity. If the nonlinear crystal is selected properly so that the phase matching condition is satisfied, a second harmonic light at a wavelength of λ/2 (i.e. 532 nm) can be generated efficiently.

Based on the description above, it is easy to understand that the heat generated in the laser crystal and nonlinear crystal can be removed easily due to the high thermal conductivity of Si substrate. In addition, since the overall cross section of the direct bonding facets are increased significantly (from 0.5 mm to more than 1 mm), the difficulty involved in direct bonding of the facet in the previous bonding process can be solved.

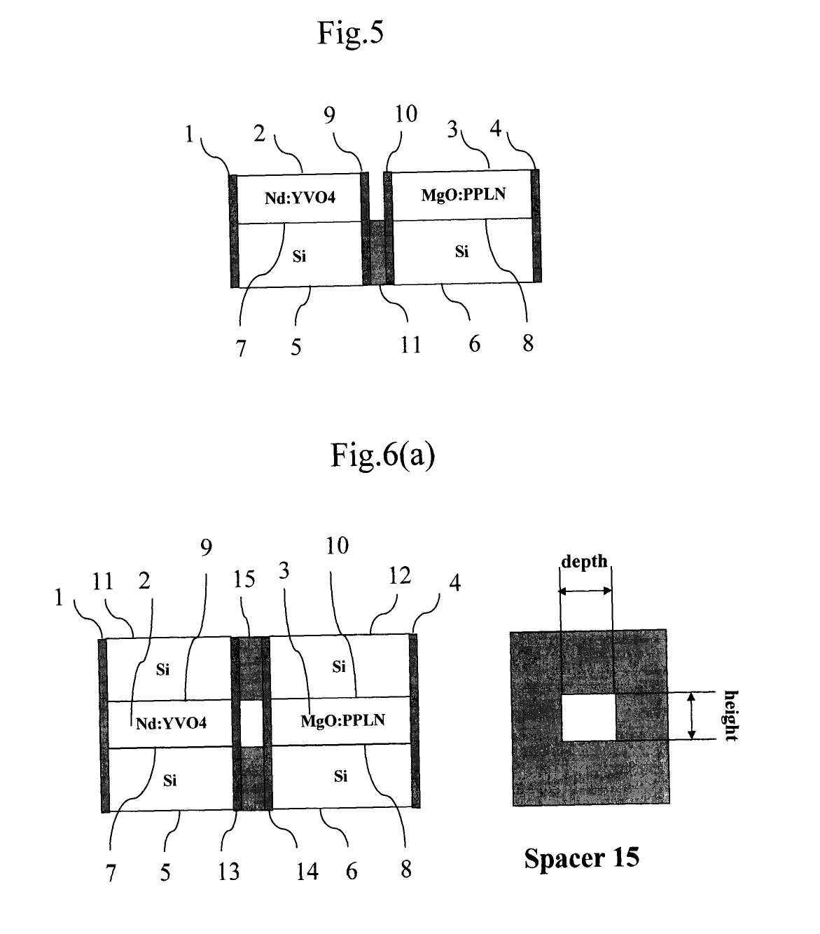

In the third preferred embodiment of the present invention, a preferred bonding structure for DPSS lasers is shown in FIG. 5. A laser crystal (e.g. Nd:YVO₄) 2 and a nonlinear crystal (e.g. MgO:PPLN) 3 are first bonded with substrates (Si substrates) 5, 6, respectively. The typical thickness of the laser crystal and nonlinear crystal can be used here (e.g. 0.5 mm), while the thickness of the Si substrates is properly selected (e.g. 0.5 mm˜2.5 mm) so that the cross section is large enough for easy facet bonding process to be carried out later. The bonding between laser crystal 2 and Si substrate 5, and between nonlinear crystal 3 and Si substrate 6 can be done using large wafer size to reduce the overall manufacturing cost. The Si substrates 5, 6 have high thermal conductivity and the same thickness. The bonding 7, 8 between the laser crystal 2 and Si substrate 5, and between nonlinear crystal 3 and Si substrate 6 can be epoxy bonding although higher cost direct bonding is also acceptable. After dicing and polishing facets, the laser crystal 2 and nonlinear crystal 3 is then bonded through a spacer 11 by epoxy. To avoid heat transfer between the laser crystal and nonlinear crystal, material with low thermal conductivity (e.g. low thermal conductive glass) is preferred for the spacer. The height of the spacer 11 should be equal or slightly less than that of the Si substrates, while the thickness of the spacer 11 can be selected in a range of several μm and mm (e.g. 1 μm˜1 mm) so that light coupling loss between the laser crystal and nonlinear crystal is negligible, no epoxy exists in optical pass, and bonding can easily be done. The facets of the laser crystal and the nonlinear crystal are in parallel and properly coated with either high reflection (HR) or anti-reflection (AR) films 1, 4, 9, 10 so that the fundamental light is confined in the laser cavity while the SHG light is coupled out the laser cavity efficiently. In the case of green DPSS lasers, film 1 has HR at wavelengths of fundamental (e.g. 1064 nm) but AR at the wavelength of the pumping light (e.g. 808 nm); film 4 has HR at fundamental light (e.g. 1064 nm) and AR at SH light (e.g. 532 nm); film 9 has AR at fundamental wavelength (e.g. 1064 nm); and film 10 has AR at fundamental wavelength (e.g. 1064 nm) but HR at the SH wavelength (e.g. 532 nm). The bonded crystal is flipped over in laser packaging so that the laser crystal and nonlinear crystal are contacted directly with a heat sink or metal mount to remove the heat generated in the crystals. The second harmonic generation occurs only in the nonlinear crystal 3 in which the QPM condition is satisfied. By pumping a laser crystal (i.e. Nd doped YVO₄) with a pump laser diode with a lasing wavelength of 808 nm, fundamental light of a wavelength λ (i.e. 1064 nm) is generated within a laser cavity. If the nonlinear crystal is selected properly so that the phase matching condition is satisfied, a second harmonic light at a wavelength of λ/2 (i.e. 532 nm) can be generated efficiently.

Based on the description above, it is easy to understand that direct bonding (which is much more expensive and difficult than epoxy bonding) is not absolutely necessary in this structure, and the heat generated in the laser crystal and nonlinear crystal can be removed relatively easily due to the thermal conductivity of Si substrate is relatively high. In addition, since the overall cross section of the direct bonding facets are increased significantly (from 0.5 mm to more than 1 mm), the difficulty involved in bonding of the thin crystal can be solved. Furthermore, considering the fact that the light beam diameter in a DPSS laser is usually only 50 μm, the thickness of the laser crystal and nonlinear crystal can be reduced down to 100˜200 μm to further enhance efficiency of removing the heat generated in the crystals.

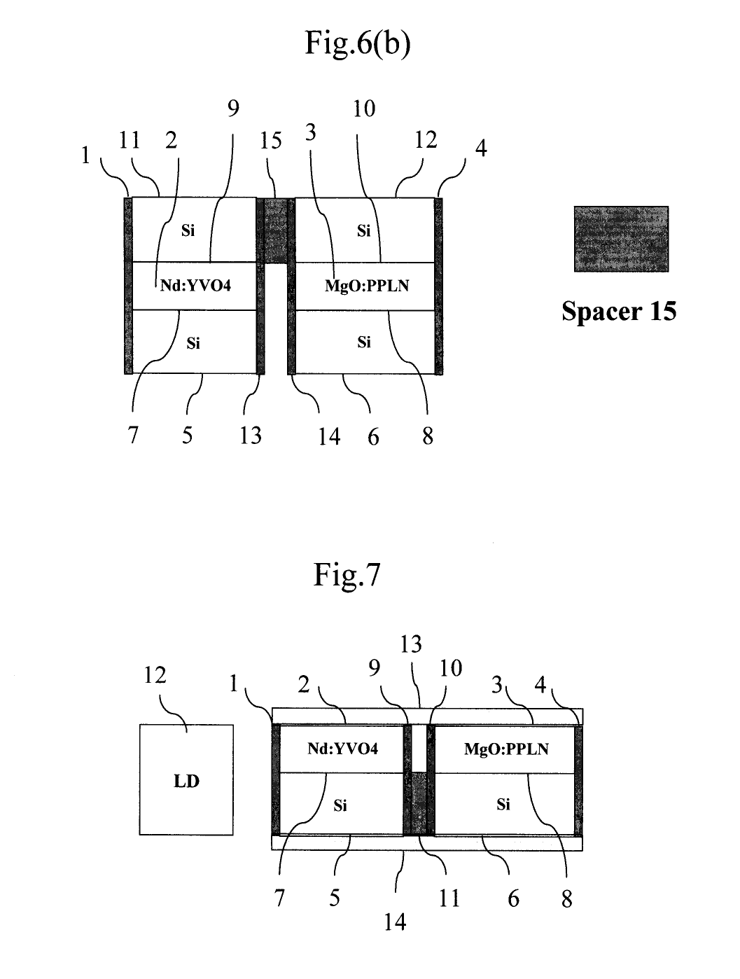

In the fourth preferred embodiment of the present invention, a preferred bonding structure for DPSS lasers is shown in FIG. 6. A laser crystal (e.g. Nd:YVO₄) 2 and a nonlinear crystal (e.g. MgO:PPLN) 3 are first bonded with substrates (Si substrates) 5, 6, respectively. The typical thickness of the laser crystal and nonlinear crystal can be used here (e.g. 0.5 mm). The thickness of the laser crystal and nonlinear crystal can be reduced down to 100˜200 μm. Then the laser crystal and nonlinear crystal are bonded with other Si substrates 11, 12, respectively. The thickness of the Si substrates is properly selected (e.g. 0.5 mm˜2.5 mm) so that the cross section is large enough for easy facet bonding process to be carried out later. The bonding between laser crystal 2 and Si substrates 5, 11, and between nonlinear crystal 3 and Si substrates 6, 12 can be done using large wafer size to reduce the overall manufacturing cost. The Si substrates 5, 6, 11, 12 have high thermal conductivity and substrates 5 and 6 have the same thickness, and substrates 11 and 12 also have the same thickness. The bonding 7, 8, 9, 10 between the laser crystal 2 and Si substrates 5, 11, and between nonlinear crystal 3 and Si substrate 6, 12 can be epoxy bonding although higher cost direct bonding is also acceptable. After dicing and polishing facets, the laser crystal 2 and nonlinear crystal 3 is then bonded through a spacer 15 by epoxy. To avoid heat transfer between the laser crystal and nonlinear crystal, material with low thermal conductivity (e.g. low thermal conductive glass) is preferred for the spacer. The spacer 15 can be either rectangular shaped hole (as shown in FIG. 6 (a)) or rectangular shaped (as shown in FIG. 6 (b)). In the case of FIG. 6(a), the outlet dimension of the spacer 15 is the same as the cross section of the facet including Si substrates and laser or nonlinear crystal, while the rectangular hole in the spacer 15 has a height equal or slightly larger than the thickness of the laser crystal or nonlinear crystal sandwiched between the Si substrates, and a depth of sufficient large for easy light coupling (e.g. 100 μm˜2 mm). In the case of FIG. 6(b), the height of the spacer 15 should be equal or slightly less than the thickness of the Si substrates, while the thickness of the spacer 11 can be selected in a range of several μm and mm (e.g. 1 μm˜1 mm) so that light coupling loss between the laser crystal and nonlinear crystal is negligible, no epoxy exists in optical pass, and bonding can easily be done. The facets of the laser crystal and the nonlinear crystal are in parallel and properly coated with either high reflection (HR) or anti-reflection (AR) films 1, 4, 13, 14 so that the fundamental light is confined in the laser cavity while the SHG light is coupled out the laser cavity efficiently. In the case of green DPSS lasers, film 1 has HR at wavelengths of fundamental (e.g. 1064 nm) but AR at the wavelength of the pumping light (e.g. 808 nm); film 4 has HR at fundamental light (e.g. 1064 nm) and AR at SH light (e.g. 532 nm); film 13 has AR at fundamental wavelength (e.g. 1064 nm); and film 14 has AR at fundamental wavelength (e.g. 1064 nm) but HR at the SH wavelength (e.g. 532 nm). The second harmonic generation occurs only in the nonlinear crystal 3 in which the QPM condition is satisfied. By pumping a laser crystal (i.e. Nd doped YVO₄) with a pump laser diode with a lasing wavelength of 808 nm, fundamental light of a wavelength λ (i.e. 1064 nm) is generated within a laser cavity. If the nonlinear crystal is selected properly so that the phase matching condition is satisfied, a second harmonic light at a wavelength of λ/2 (i.e. 532 nm) can be generated efficiently.

Based on the description above, it is easy to understand that direct bonding (which is much more expensive and difficult than epoxy bonding) is not absolutely necessary in this structure, and the heat generated in the laser crystal and nonlinear crystal can be removed relatively easily due to the high thermal conductivity of Si substrate. In addition, since the overall cross section of the direct bonding facets are increased significantly (from 0.5 mm to more than 1 mm), the difficulty involved in bonding of the thin crystal can be solved. Furthermore, considering the fact that the light beam diameter in a DPSS laser is usually only 50 μm, the thickness of the laser crystal and nonlinear crystal can be reduced down to 100˜200 μm to further enhance efficiency of removing the heat generated in the crystals.

In the fifth preferred embodiment of the present invention, a preferred structure for DPSS SHG lasers is shown in FIG. 7. In this structure, a bonded laser and nonlinear crystal described in the third preferred embodiment of the present invention is used as an example to achieve green DPSS SHG lasers. The bonded crystal is mounted in a holder with two metal surfaces 13, 14 to sandwich the bonded crystal so that heat can be removed effectively. By pumping a laser crystal (i.e. Nd doped YVO₄) with a pump laser diode 12 with a lasing wavelength of 808 nm, fundamental light of a wavelength λ (i.e. 1064 nm) is generated within a laser cavity. If the period of the QPM crystal is selected properly so that the QPM wavelength of the nonlinear crystal matches with the fundamental wavelength, a second harmonic light at a wavelength of λ/2 (i.e. 532 nm) can be generated efficiently. The period of the domain inversion grating Λ is decided by the QPM condition (i.e. 2 (n_{2ω}-n_{ω})=λ/Λ, where n_{2ω} and n_{ω} are refractive indices at SH and fundamental light, respectively).

To achieve efficient wavelength conversions, reduce size and packaging cost of the lasers, a bonded structure is employed, in which the laser crystal 2 and nonlinear crystal 3 is bonded together through a spacer 11, as shown in FIG. 7. To confine the fundamental light within the laser cavity, reduce coupling loss of pump power and couple SH light efficiently from the cavity, the laser crystal 3 is coated with a film 1 and 9, while the nonlinear crystal is coated with a film of 4 and 10. Film 1 has HR at wavelengths of fundamental (e.g. 1064 nm) but AR at the wavelength of the pumping light (e.g. 808 nm); film 4 has HR at fundamental light (e.g. 1064 nm) and AR at SH light (e.g. 532 nm); film 9 has AR at fundamental wavelength (e.g. 1064 nm); and film 10 has AR at fundamental wavelength (e.g. 1064 nm) but HR at the SH wavelength (e.g. 532 nm).

The above embodiments have described the bonded MgO:PPLN nonlinear crystal for green laser with the intra-cavity configuration. Of course, the methods described in the present invention can be applied to other bonded nonlinear crystals such as MgO:PPLT, PPKTP, etc.

The above embodiments have described SHG green laser with the bonded nonlinear crystal and the intra-cavity configuration. Of course, the methods described in the present invention can be applied to other SHG lasers such as SHG blue lasers, etc.

The above embodiments have described SHG lasers using the bonded nonlinear crystal. Of course, the methods described in the present invention can also be applied to other optical nonlinear processes such as optical parametric oscillation, difference frequency generation, etc.

1. A method for packaging optical nonlinear crystal which is bonded with a laser crystal and to achieve efficient wavelength conversion in an intra-cavity configuration.

2. The nonlinear crystal and laser crystal in claim 1 are first bonded with relatively thick substrates, respectively.

3. The substrates in claim 2 have high thermal conductivity and the same thickness for both nonlinear crystal bonding and laser crystal bonding.

4. The bonding between the nonlinear crystal and substrate in claim 2 is achieved through either direct bonding or epoxy bonding.

5. The bonding between the laser crystal and substrate in claim 2 is achieved through either direct bonding or epoxy bonding.

6. The bonding of nonlinear crystal and laser crystal in claim 2 is carried out over a large area, respectively.

7. The bonded nonlinear crystal and laser crystal in claim 2 are bonded directly without using epoxy after dicing and facet polishing.

8. The thickness of the bonded nonlinear crystal and laser crystal in claim 2 is reduced by surface polishing.

9. The bonded nonlinear crystal and laser crystal in claim 8 are bonded directly without using epoxy after dicing and facet polishing.

10. The two out facets of the bonded nonlinear crystal and laser crystal in claim 7 are precisely in parallel with each other.

11. The two out facets of the bonded nonlinear crystal and laser crystal in claim 7 are properly coated so that the fundamental light is confined within a laser cavity, while the second harmonic light can be extracted efficiently from the out facet of the nonlinear crystal.

12. The bonded nonlinear crystal and laser crystal in claim 8 are then bonded with the second substrates, in which nonlinear crystal and laser crystal are sandwiched between two substrates.

13. The second substrates in claim 12 have high thermal conductivity.

14. The second substrates in claim 12 have the same thickness for the nonlinear crystal and laser crystal.

15. The bonding between the bonded nonlinear crystal and the second substrate in claim 12 is achieved through either direct bonding or epoxy bonding.

16. The bonding between the bonded laser crystal and the second substrate in claim 12 is achieved through either direct bonding or epoxy bonding.

17. The bonding of nonlinear crystal and laser crystal in claim 12 is carried out over a large area, respectively.

18. The sandwich bonded nonlinear crystal and laser crystal in claim 12 are bonded directly without using epoxy after dicing and facet polishing.

19. The sandwich bonded nonlinear crystal and laser crystal in claim 12 are bonded through a spacer by using epoxy after dicing, facet polishing and facet coating.

20. The spacer in claim 19 has low thermal conductivity to prevent heat exchange between the nonlinear crystal and laser crystal.

21. The spacer in claim 19 is properly selected so that maximum optical aperture is achieved for the nonlinear crystal and laser crystal.

22. The two out facets of the sandwich bonded nonlinear crystal and laser crystal in claim 18 are precisely in parallel with each other.

23. The facets of the sandwich bonded nonlinear crystal and laser crystal in claim 18 are properly coated so that the fundamental light is confined within a laser cavity, while the second harmonic light can be extracted efficiently from the out facet of the nonlinear crystal without reflection loss at the facets.

24. The bonded nonlinear crystal and laser crystal in claim 9 is set in a metal holder, in which the surfaces of the nonlinear crystal and laser crystal, as well as the surface of the substrates are contacted with the metal to effectively remove the heat generated in the nonlinear crystal and laser crystal.

25. The sandwich bonded nonlinear crystal and laser crystal in claim 18 is set in a metal holder, in which the surfaces of the nonlinear crystal and laser crystal, as well as the surface of the substrates are contacted with the metal to effectively remove the heat generated in the nonlinear crystal and laser crystal.
